(19) United States
(12) Patent Application Publication
(10) Pub. No.: US 2016/0117032 A1
(43) Pub. Date: Apr. 28, 2016

(54) TOUCH PANEL AND TOUCH DISPLAY APPARATUS INCLUDING THE SAME

(71) Applicant: InnoLux Corporation, Miao-Li County (TW)

(72) Inventors: Chen-Yu LIN, Miao-Li County (TW); Yu-Heng CHEN, Miao-Li County (TW); Pei-Chi HSU, Miao-Li County (TW); Hsiao-Chan WANG, Miao-Li County (TW); Ping-Hsu CHENG, Miao-Li County (TW)

(21) Appl. No.: 14/886,191

(22) Filed: Oct. 19, 2015

(30) Foreign Application Priority Data
Oct. 24, 2014 (TW) 103136766

(51) Int. Cl. G06F 3/041

(52) U.S. Cl. CPC G06F 3/0412; G06F 2203/04102; G06F 2203/04103

(57) ABSTRACT

Disclosed is a touch panel including a substrate with a touch sensing region and a non-touch sensing region, wherein the non-touch sensing region surrounds the touch sensing region. A plurality of sensing electrodes are disposed on the touch sensing region. A plurality of metal traces are disposed on the non-touch sensing region and electrically connected to the sensing electrodes. A passivation layer covers the metal trace, wherein a distance between an edge of the passivation layer and the metal traces is greater than or equal to at least 140 micrometers.

### CROSS REFERENCE TO RELATED APPLICATIONS

This application claims priority of Taiwan Patent Application No. 103136766, filed on Oct. 24, 2014, the entirety of which is incorporated by reference herein.

### BACKGROUND

1. Technical Field

The disclosure relates to a touch panel, and in particular relates to its traces and corresponding passivation layer.

2. Description of the Related Art

A conventional touch panel usually includes a touch array, a bonding pad set, and traces on a substrate. The traces may be electrically connected to the bonding pad set and sensing electrodes of the touch array. Bonding pads of the bonding pad set are usually electrically connected to an external circuit (e.g. a flexible circuit board), such that electrical currents or signals from the external circuit can be transferred to the touch array through the bonding pads and the traces for driving the touch panel.

In conventional processes, a passivation layer is usually adopted to protect the touch panel. However, moisture will permeate to corrode the traces through a crevice between the passivation layer and the substrate after the touch panel being used for a while. Accordingly, a novel product specification is called for to confirm that the passivation layer can protect the traces from moisture and corrosion after the touch panel has been used for a long time.

### BRIEF SUMMARY

One embodiment of the disclosure provides a touch panel, comprising: a substrate including a touch sensing region and a non-touch sensing region, wherein the non-touching sensing region surrounds the touch sensing region; a plurality of sensing electrodes on the touch sensing region; a plurality of metal traces on the non-touching sensing region, wherein the metal traces electrically connect to the sensing electrodes; a passivation layer covering the metal traces, wherein a distance between an edge of the passivation layer and the metal traces is greater than or equal to at least 140 micrometers.

One embodiment provides the described touch panel, wherein the distance between the edge of the passivation layer and the metal traces is between 140 micrometers and 390 micrometers.

One embodiment of the disclosure provides the described touch panel, further comprising a plurality of bonding pads electrically connected to the metal traces, and the bonding pads extend out of the edge of the passivation layer for connecting to an external circuit.

One embodiment of the disclosure provides the described touch panel, wherein a distance between the edge of the passivation layer and the metal traces electrically connected to the bonding pads is greater than or equal to at least 140 micrometers.

One embodiment of the disclosure provides the described touch panel, wherein the passivation layer continuously covers the non-touch sensing region and the touch sensing region, and wherein the passivation layer completely covers the touch sensing region.

One embodiment of the disclosure provides the described touch panel, wherein the passivation layer includes a first edge on the non-touch sensing region, and a second edge on the touch sensing region, wherein the passivation layer continuously covers a region between the first edge and the second edge.

One embodiment of the disclosure provides the described touch panel, wherein the second edge is located on the sensing electrodes.

One embodiment of the disclosure provides the described touch panel, wherein the second edge is located on the sensing electrodes the described touch panel, wherein the second edge is located between the sensing electrodes and the metal traces.

One embodiment of the disclosure provides a touch display apparatus, comprising: a touch display panel including a top substrate, a bottom substrate, and a display medium disposed between the top substrate and the bottom substrate, wherein the top substrate includes a touch sensing region and a non-touch sensing region; a plurality of sensing electrodes on the touch sensing region; a plurality of metal traces on the non-touching sensing region, wherein the metal traces electrically connect to the sensing electrodes; a passivation layer covering the metal traces, wherein a distance between an edge of the passivation layer and the metal traces is greater than or equal to at least 140 micrometers.

One embodiment of the disclosure provides the described touch display apparatus, further comprising a cover plate including a black matrix formed thereon, wherein the black matrix overlaps the metal traces with respect to the top substrate.

One embodiment of the disclosure provides a touch display apparatus, comprising: a display panel including a top substrate, a bottom substrate, and a display medium disposed between the top substrate and the bottom substrate; and a touch panel, disposed on the display panel, including: a touch substrate including a touch sensing region and a non-touch sensing region, wherein the non-touching sensing region surrounds the touch sensing region; a plurality of sensing electrodes on the touch sensing region; a plurality of metal traces on the non-touching sensing region, wherein the metal traces electrically connect to the sensing electrodes; a passivation layer covering the metal traces, wherein a distance between an edge of the passivation layer and the metal traces is greater than or equal to at least 140 micrometers.

One embodiment of the disclosure provides the described touch display apparatus, wherein the touch panel further includes a black matrix formed between the touch substrate and the metal traces.

One embodiment of the disclosure provides the described touch display apparatus, further comprising a cover plate disposed on the touch panel, the cover plate including a black matrix formed thereon, wherein the black matrix overlaps the metal traces with respect to the touch substrate.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1A, 1B, and 1C show top views of touch panels in embodiments of the disclosure;

FIGS. 2A and 2B show cross-sections corresponding to the touch panel in FIG. 1A;

FIGS. 2C and 2D show cross-sections corresponding to the touch panel in FIG. 1B;

FIGS. 2E and 2F show cross-sections corresponding to the touch panel in FIG. 1C; and

FIGS. 3, 4, and 5 show touch display apparatuses in embodiments of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

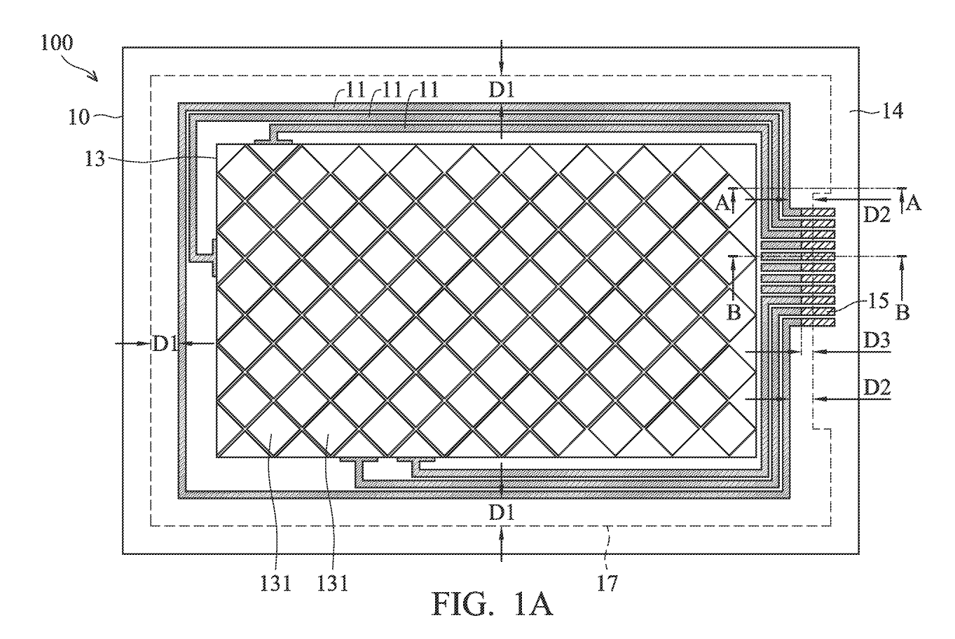

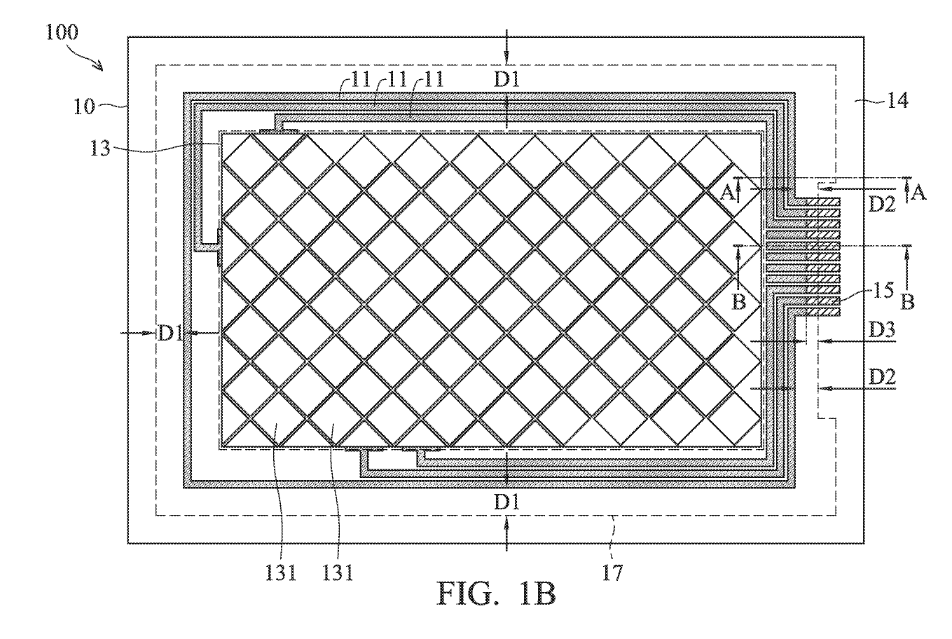

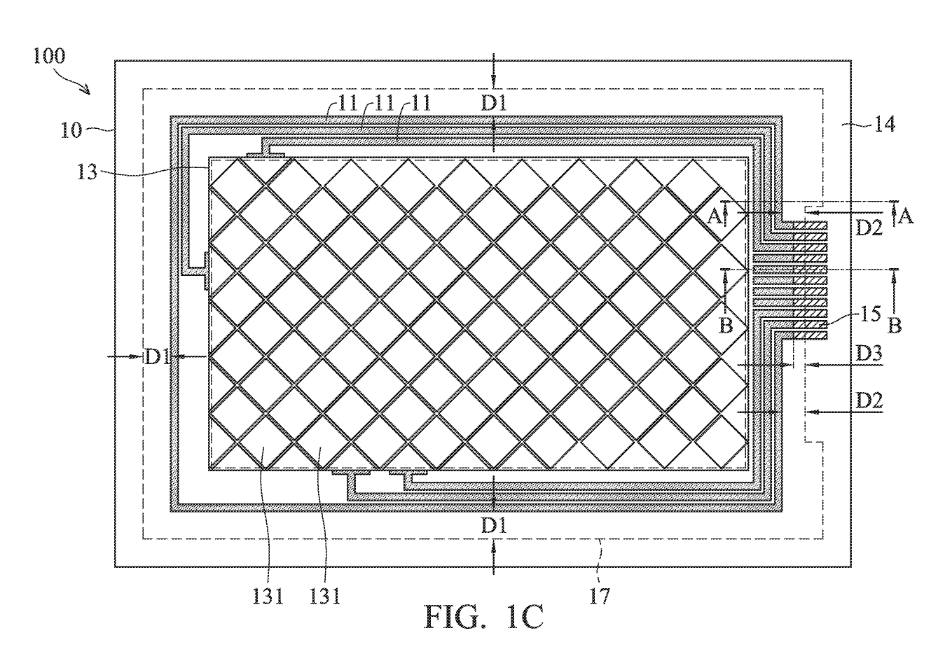

As shown in FIG. 1A, a touch panel 100 includes a substrate 10 having a touch sensing region 13 with a plurality of sensing electrodes 131 thereon. The substrate 10 without the sensing electrodes 131 is defined as a non-touch sensing region 14, and the non-touch sensing region 14 surrounds the touch sensing region 13. The metal traces 11 on the substrate 10 are located on the non-touch sensing region 14 and electrically connected to the sensing electrodes 131 of the touch sensing region 13. The metal traces 11 are electrically connected to the bonding pads 15, and the bonding pads 15 are electrically connected to an external circuit such as a flexible circuit board (not shown). The electrical current or signals of the external circuit can be transferred to the touch sensing region 13 through the bonding pads 15 and the metal traces 11, thereby driving the touch panel 10. In one embodiment, the substrate 10 can be glass or plastic. In one embodiment, the metal traces 11 can be aluminum, molybdenum, copper, silver, an alloy thereof, or a multi-layer structure thereof, and the bonding pads 15 can be indium tin oxide (ITO) or indium zinc oxide (IZO).

The passivation layer 17 covers and protects the metal traces 11 and the sensing region 13. As shown in FIG. 1A, distances such as D1, D2, and D3 of an edge of the passivation layer 17 and all of the metal traces 11 are greater than or equal to at least 140 micrometers. If the distance between the edge of the passivation layer 17 and any one of the metal traces 11 is less than 140 micrometers, the environmental moisture may permeate into the crevice between the substrate 10 and the passivation layer 17 after the touch panel 100 is used for a while, thereby corroding the metal traces 11 and reducing the reliability of the touch panel 100. The maximum distance between the edge of the passivation layer 17 and all of the metal traces 11 is determined by a distance between an edge of the substrate 10 and the metal traces 11. In one embodiment, the distance between the edge of the substrate 10 and the metal traces 11 is 390 micrometers. As such, the maximum distance between the edge of the passivation layer 17 and all of the metal traces is 390 micrometers. However, the above embodiment is just illustrative and not for limiting the disclosure. It should be understood that the distance between the edge of the substrate 10 and the outermost metal trace 11 should be greater than or equal to 140 micrometers. If the distance between the edge of the substrate 10 and the metal traces 11 is less than 140 micrometers, the distance between the edge of the passivation layer 17 and the outermost metal trace 11 must be less than 140 micrometers (even if the passivation layer 17 covers all of the substrate 10). Therefore, the passivation layer 17 cannot efficiently block the moisture. In one embodiment, the passivation layer 17 can be photo curable resin or thermoset resin.

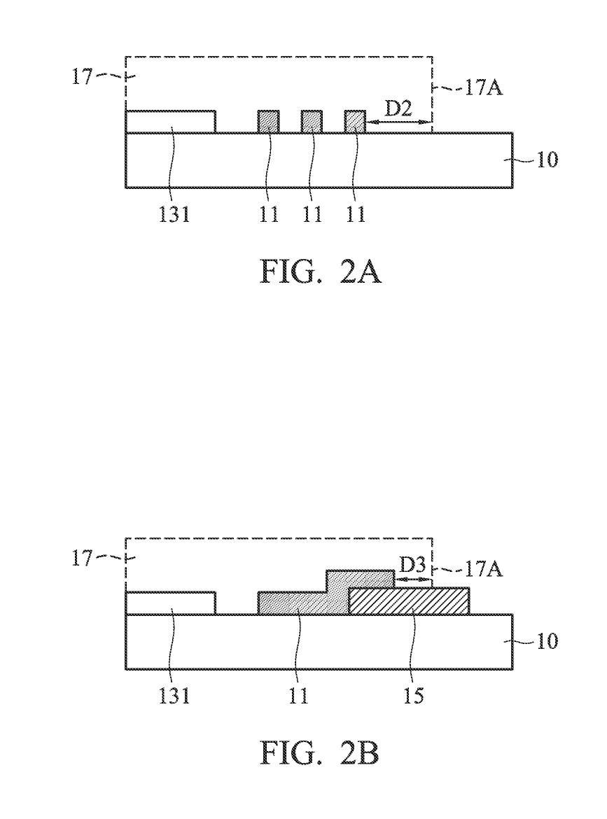

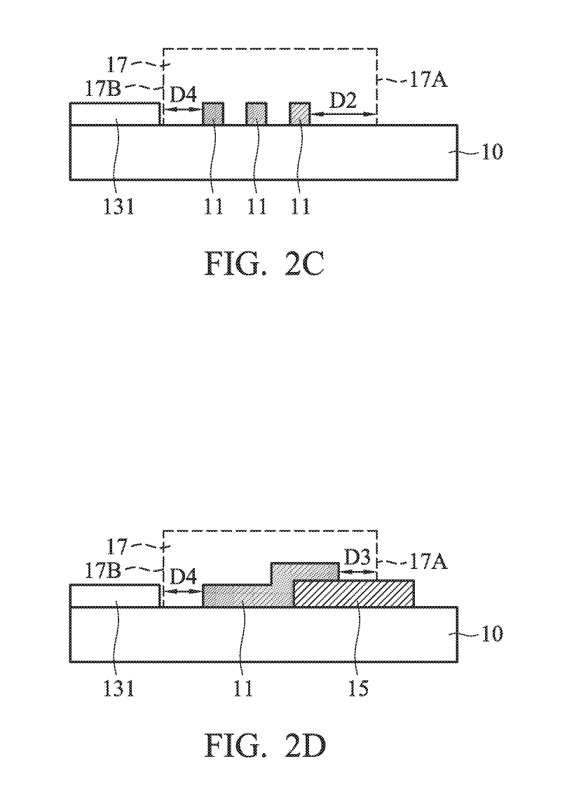

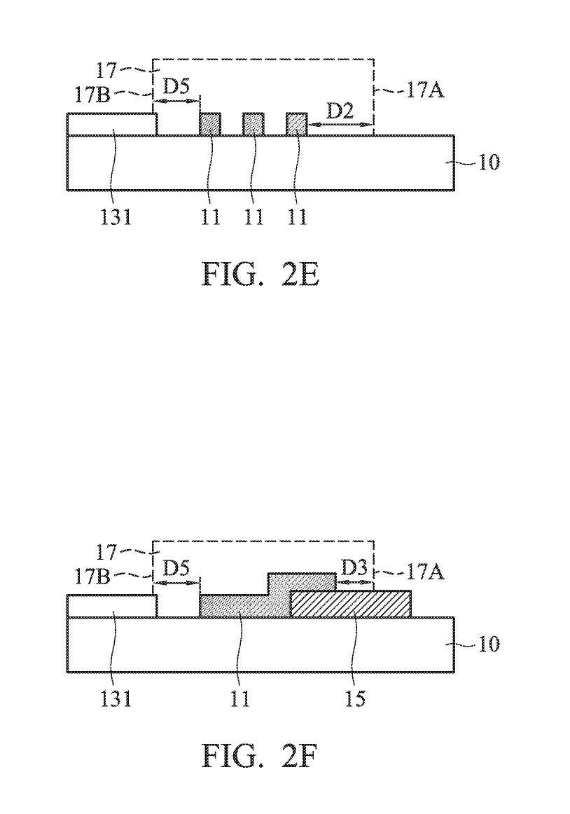

FIG. 2A is a cross-section along the cross line A-A in FIG. 1A, and FIG. 2A is a cross-section along the cross line B-B in FIG. 1A, respectively. As shown in FIGS. 1 and 2B, the bonding pad 15 should extend out of the passivation layer 17 to electrically connect to the external circuit, and the distance D3 between the metal trace 11 on the bonding pad 15 and the edge of the passivation layer 17 is especially short. However, the distance D3 should be greater than or equal to 140 micrometers. If the distance between the edge of the passivation layer 17 and any one of the metal traces 11 is less than 140 micrometers, the environmental moisture may permeate into the crevice between the bonding pad 15 and the passivation layer 17 after the touch panel 100 being used for a while, thereby corroding the metal traces 11 and reducing the reliability of the touch panel 100.

Note that the bonding pad 15 is located under the metal trace 11 in FIG. 2B. The bonding pad 15 can be located on the metal trace 11 if necessary. Whatever the location of the bonding pad 15 is, the bonding pad 15 may electrically connect the metal traces 11 to the external circuit (not shown).

In the embodiment as shown in FIGS. 2A and 2B, the passivation layer 17 not only covers the metal traces 11 and the bonding pads 15, but also continuously completely covers the touch sensing region 13. However, the passivation layer 17 may cover none of the touch sensing region 13, or only a part of the touch sensing region 13 in other embodiments. The selectively covering passivation layer 17 described above includes a first edge 17A on the non-touch sensing region 14, and a second edge 17B on the touch sensing region 13, and the passivation layer 17 continuously covers a region between the first edge 17A and the second edge 17B.

In one embodiment, the second edge 17B of the passivation layer 17 is located between the sensing electrodes 131 and the metal traces 11, as shown in FIG. 1B. FIG. 2C is a cross-section along the cross line A-A in FIG. 1B, and FIG. 2D is a cross-section along the cross line B-B in FIG. 1B. The distance D4 between the second edge 17B of the passivation layer 17 and the metal trace 11 should be greater than or equal to at least 140 micrometers.

In one embodiment, the second edge 17B of the passivation layer 17 is located on the sensing electrodes 131, as shown in FIG. 1C. FIG. 2E is a cross-section along the cross line A-A in FIG. 1C, and FIG. 2F is a cross-section along the cross line B-B in FIG. 1C. The distance D5 between the second edge 17B of the passivation layer 17 and the metal trace 11 should be greater than or equal to at least 140 micrometers. As shown in the embodiments of FIG. 1B (and FIGS. 2C and 2D) and FIG. 1C (and FIGS. 2E and 2F), there is substantially no passivation layer 17 on the touch sensing region 13. While the touch panel is integrated with a display panel, the light transmittance of a display region of the display panel (substantially overlapping the touch sensing region 13) can be further improved.

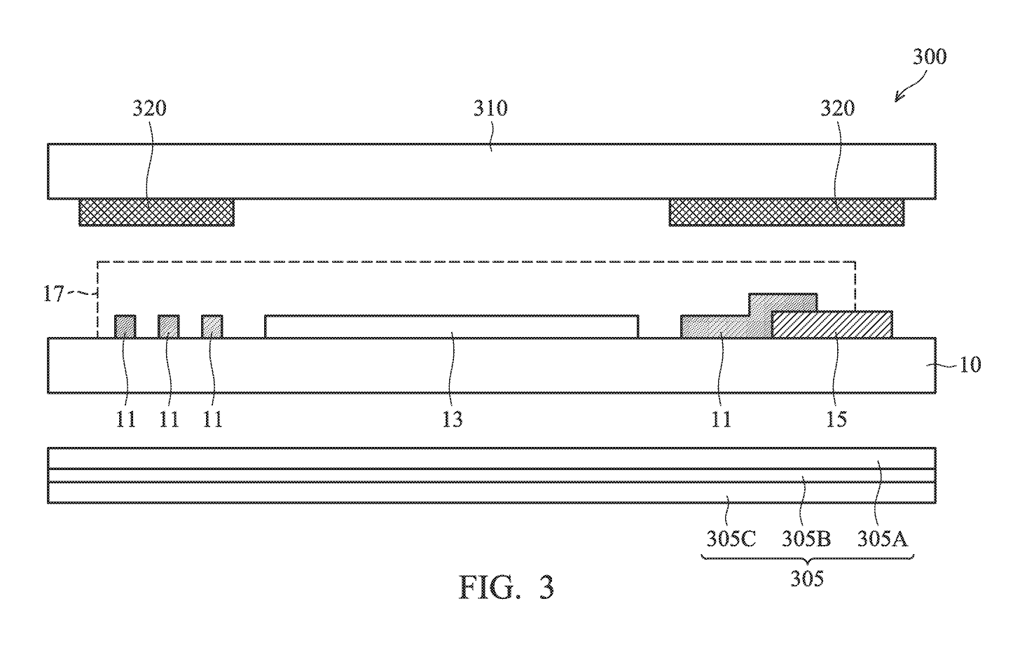

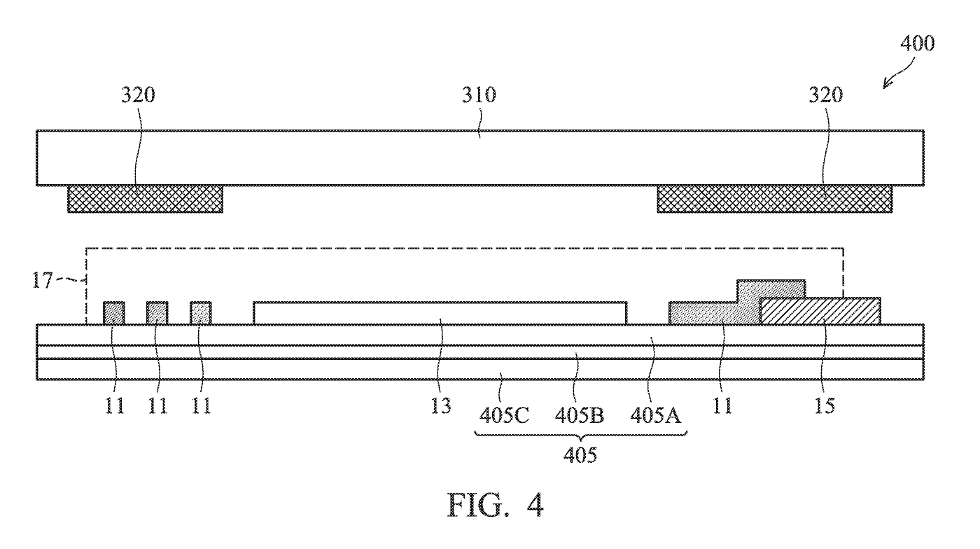

The touch panel 100 can be integrated into any conventional touch display apparatus. As shown in FIG. 3, a touch display apparatus 300 includes a display panel 305 and a touch panel 100 on the display panel 305. The display panel 305 may include a top substrate 305A, a bottom substrate 305C, and a display medium 305B disposed between the top substrate 305A and the bottom substrate 305C. The display medium 305B can be liquid crystal, organic light emitting diode, or inorganic light emitting diode. The touch panel may includes a touch substrate 10, wherein the touch substrate 10 includes a touch sensing region 13 and a non-touch sensing region surrounding the touch-sensing region 13, as shown in FIG. 1A. A plurality of sensing electrodes are disposed on the touch sensing region 13. A plurality of metal traces 11 are disposed on the non-touching sensing region. The metal traces 11 electrically connect to the sensing electrodes. A passivation layer 17 covers the metal traces, and a distance between an edge of the passivation layer 17 and the metal traces 11 is greater than or equal to at least 140 micrometers. Furthermore, a cover plate 310 can be disposed on the touch panel. The cover plate 310 includes a black matrix 320 formed thereon, wherein the black matrix 320 overlaps the metal traces 11 with respect to the touch substrate 10. The touch display apparatus 300 is a so-called glass-to-glass (GG) structure. Note that the touch panel in FIG. 3 corresponds to the design in FIG. 1A, but the designs in FIGS. 1B and 1C are also suitable for the touch display apparatus 300. As shown in FIG. 4, the touch panel 100 can be integrated in the display panel to form a touch display apparatus 400. The touch display apparatus 400 includes a touch display panel including a top substrate 405A, a bottom substrate 405C, and a display medium 405B disposed between the top substrate 405A and the bottom substrate 405C, wherein the top substrate 405A includes a touch sensing region 13 and a non-touch sensing region surrounding the touch sensing region, as shown in FIG. 1A. The display medium 405B can be liquid crystal, organic light emitting diode, or inorganic light emitting diode. A plurality of sensing electrodes are disposed on the touch sensing region 13. A plurality of metal traces 11 are disposed on the non-touching sensing region, wherein the metal traces 11 electrically connect to the sensing electrodes. A passivation layer 17 covers the metal traces 11, wherein a distance between an edge of the passivation layer 17 and the metal traces 11 is greater than or equal to at least 140 micrometers. Furthermore, a cover plate 310 can be disposed on the touch panel, The cover plate 310 includes a black matrix 320 formed thereon, wherein the black matrix 320 overlaps the metal traces 11 with respect to the top substrate 405A. The touch display apparatus 400 is so called touch on display (TOD) structure. Note that the touch panel in FIG. 4 corresponds to the touch panel in FIG. 1A, but the designs of the touch panels in FIGS. 1B and 1C are also suitable for the touch display apparatus.

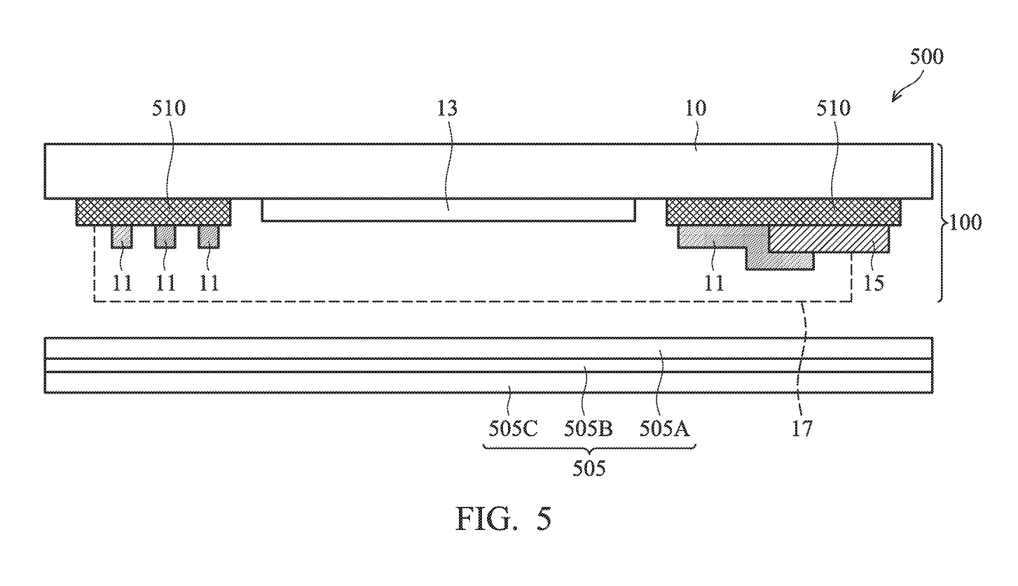

As shown in FIG. 5, a touch display apparatus 500, includes a display panel 505 and a touch panel 100 on the display panel 505. The display panel 505 includes a top substrate 505A, a bottom substrate 505C, and a display medium 505B disposed between the top substrate 505A and the bottom substrate 505C. The display medium 505B can be liquid crystal, organic light emitting diode, or inorganic light emitting diode. The touch panel 100 includes a touch substrate 10 including a touch sensing region 13 and a non-touch sensing region surrounding the touch sensing region 13. A plurality of sensing electrodes are disposed on the touch sensing region 13. A plurality of metal traces 11 are disposed on the non-touching sensing region, wherein the metal traces 11 electrically connect to the sensing electrodes. A passivation layer 17 covers the metal traces, wherein a distance between an edge of the passivation layer 17 and the metal traces 11 is greater than or equal to at least 140 micrometers. Furthermore, a black matrix 510 can be formed between the touch substrate 10 and the metal traces 11. The touch display apparatus 500 is so called one glass solution (OGS) structure. Note that the touch panel in FIG. 5 corresponds to the touch panel in FIG. 1A, but the designs of the touch panels in FIGS. 1B and 1C are also suitable for the touch display apparatus.

Note that the touch panel of the disclosure is not limited to the above structures. The product specification above can be applied to any touch panel with a passivation layer for protecting the metal traces to improve product properties.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

Bonding pads and metal traces were formed on a substrate corresponding to FIG. 1A, wherein the terminals of the metal traces were located on the bonding pads. In this example, the bonding pads were ITO, metal traces were a bi-layer structure of aluminum/molybdenum, and the substrate was glass. The bonding pads and the metal traces were formed by general processes such as deposition, lithography, etching, and the like.

A passivation layer was formed to cover the metal traces and the substrate. In this example, the passivation layer was photo curable resin formed by lithography. As shown in FIG. 1A, a distance D3 between the metal traces on the bonding pads and the edge of the passivation layer was 50 micrometers.

The touch panel was tested under a relative humidity of 85% and a temperature of 85° C. to measure the electrical properties of the metal traces after 144 hours, 288 hours, and 500 hours, respectively. The results are tabulated in Table 1.

### Example 2

Example 2 was similar to Example 1. The difference in Example 2 was the distance D3 between the metal traces on the bonding pads and the edge of the passivation layer being 100 micrometers. The other factors such as the materials and formation processes of the substrate, the bonding pads, the metal traces, and the passivation layer were the same as that in Example 1. The touch panel was tested under a relative humidity of 85% and a temperature of 85° C. to measure the electrical property of the metal traces after 144 hours, 288 hours, and 500 hours, respectively. The results are tabulated in Table 1.

### Example 3

Example 3 was similar to Example 1. The difference in Example 3 was the distance D3 between the metal traces on the bonding pads and the edge of the passivation layer being 131 micrometers. The other factors such as the materials and formation processes of the substrate, the bonding pads, the metal traces, and the passivation layer were the same as that in Example 1. The touch panel was tested under a relative humidity of 85% and a temperature of 85° C. to measure the electrical property of the metal traces after 144 hours, 288 hours, and 500 hours, respectively. The results are tabulated in Table 1.

### Example 4

Example 4 was similar to Example 1. The difference in Example 4 was the distance D3 between the metal traces on the bonding pads and the edge of the passivation layer being 140 micrometers. The other factors such as the materials and formation processes of the substrate, the bonding pads, the metal traces, and the passivation layer were the same as that in Example 1. The touch panel was tested under a relative humidity of 85% and a temperature of 85° C. to measure the electrical property of the metal traces after 144 hours, 288 hours, and 500 hours, respectively. The results are tabulated in Table 1.

### Example 5

Example 5 was similar to Example 1. The difference in Example 5 was the distance D3 between the metal traces on the bonding pads and the edge of the passivation layer being 390 micrometers. The other factors such as the materials and formation processes of the substrate, the bonding pads, the metal traces, and the passivation layer were the same as that in Example 1. The touch panel was tested under a relative humidity of 85% and a temperature of 85° C. to measure the electrical property of the metal traces after 144 hours, 288 hours, and 500 hours, respectively. The results are tabulated in Table 1.

### Example 6

Example 6 was similar to Example 1. The difference in Example 6 was the distance D3 between the metal traces on the bonding pads and the edge of the passivation layer being 2473 micrometers. The other factors such as the materials and formation processes of the substrate, the bonding pads, the metal traces, and the passivation layer were the same as that in Example 1. The touch panel was tested under a relative humidity of 85% and a temperature of 85° C. to measure the electrical property of the metal traces after 144 hours, 288 hours, and 500 hours, respectively. The results are tabulated in Table 1.

TABLE 1

| | Distance between the | | | |
|---|---|---|---|---|
| | edge of the passivation | | | |
| | layer and the | | | |
| | metal traces on the | Electrical measurement | | |
| | bonding pads | 144 | 288 | 500 |
| | (micrometers) | hours | hours | hours |
| Example 1 | 50 | Success | Fail | Fail |
| Example 2 | 100 | Fail | Fail | Fail |
| Example 3 | 131 | Success | Success | Fail |
| Example 4 | 140 | Success | Success | Success |
| Example 5 | 390 | Success | Success | Success |
| Example 6 | 2473 | Success | Success | Success |

As shown in Table 1, if the distance between the edge of the passivation layer and the metal traces on the bonding pads was less than 140 micrometers, the metal traces would electrically fail after longtime use.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising:
a substrate including a touch sensing region and a non-touch sensing region, wherein the non-touching sensing region surrounds the touch sensing region;
a plurality of sensing electrodes on the touch sensing region;
a plurality of metal traces on the non-touching sensing region, wherein the metal traces electrically connect to the sensing electrodes;
a passivation layer covering the metal traces, wherein a distance between an edge of the passivation layer and the metal traces is greater than or equal to at least 140 micrometers.

2. The touch panel as claimed in claim 1, wherein the distance between the edge of the passivation layer and the metal traces is between 140 micrometers and 390 micrometers.

3. The touch panel as claimed in claim 1, further comprising a plurality of bonding pads electrically connected to the metal traces, and the bonding pads extend out of the edge of the passivation layer for connecting to an external circuit.

4. The touch panel as claimed in claim 3, wherein a distance between the edge of the passivation layer and the metal traces electrically connected to the bonding pads is greater than or equal to at least 140 micrometers.

5. The touch panel as claimed in claim 1, wherein the passivation layer continuously covers the non-touch sensing region and the touch sensing region, and wherein the passivation layer completely covers the touch sensing region.

6. The touch panel as claimed in claim 1, wherein the passivation layer includes a first edge on the non-touch sensing region, and a second edge on the touch sensing region, wherein the passivation layer continuously covers a region between the first edge and the second edge.

7. The touch panel as claimed in claim 6, wherein the second edge is located on the sensing electrodes.

8. The touch panel as claimed in claim 6, wherein the second edge is located between the sensing electrodes and the metal traces.

9. A touch display apparatus, comprising:
a touch display panel including a top substrate, a bottom substrate, and a display medium disposed between the top substrate and the bottom substrate, wherein the top substrate includes a touch sensing region and a non-touch sensing region;
a plurality of sensing electrodes on the touch sensing region;
a plurality of metal traces on the non-touching sensing region, wherein the metal traces electrically connect to the sensing electrodes;
a passivation layer covering the metal traces, wherein a distance between an edge of the passivation layer and the metal traces is greater than or equal to at least 140 micrometers.

10. The touch display apparatus as claimed in claim 9, further comprising a cover plate including a black matrix formed thereon, wherein the black matrix overlaps the metal traces with respect to the top substrate.

11. A touch display apparatus, comprising:
a display panel including a top substrate, a bottom substrate, and a display medium disposed between the top substrate and the bottom substrate; and
a touch panel, disposed on the display panel, including:
a touch substrate including a touch sensing region and a non-touch sensing region, wherein the non-touching sensing region surrounds the touch sensing region;
a plurality of sensing electrodes on the touch sensing region;
a plurality of metal traces on the non-touching sensing region, wherein the metal traces electrically connect to the sensing electrodes;
a passivation layer covering the metal traces, wherein a distance between an edge of the passivation layer and the metal traces is greater than or equal to at least 140 micrometers.

12. The touch display apparatus as claimed in claim 11, wherein the touch panel further includes a black matrix formed between the touch substrate and the metal traces.

13. The touch display apparatus as claimed in claim 11, further comprising a cover plate disposed on the touch panel, the cover plate including a black matrix formed thereon, wherein the black matrix overlaps the metal traces with respect to the touch substrate.
